(19) United States
(12) Patent Application Publication
(10) Pub. No.: US 2026/0080234 A1
(43) Pub. Date: Mar. 19, 2026

(54) NEURAL NETWORK DEVICE AND SIGNAL PROCESSING METHOD

(71) Applicant: KABUSHIKI KAISHA TOSHIBA, Kawasaki-shi Kanagawa (JP)

(72) Inventors: Kumiko NOMURA, Shinagawa Tokyo (JP); Yoshifumi NISHI, Yokohama Kanagawa (JP); Kazuki MINEGISHI, Yokohama Kanagawa (JP); Masato ODA, Yokohama Kanagawa (JP)

(73) Assignee: KABUSHIKI KAISHA TOSHIBA, Kawasaki-shi Kanagawa (JP)

(21) Appl. No.: 19/309,880

(22) Filed: Aug. 26, 2025

(30) Foreign Application Priority Data
Sep. 17, 2024 (JP) 2024-159989

(51) Int. Cl. G06N 3/063

(52) U.S. Cl. CPC G06N 3/063

(57) ABSTRACT

A neural network device according to an embodiment includes a plurality of synapse circuits and a plurality of neuron circuits. Each of the synapse circuits acquires one or more spike signals output from one of the neuron circuits, and, in response to acquiring the spike signals, outputs a synaptic current with a current amount corresponding to an assigned synaptic weight and the spike signals. A first neuron circuit out of the neuron circuits outputs N spike signals as the one or more spike signals. The first neuron circuit includes a spike output circuit to output at least an n-th spike signal out of the N spike signals when the membrane potential is higher than an n-th threshold potential out of the N threshold potentials different from each other.

### CROSS-REFERENCE TO RELATED APPLICATIONS

This application is based upon and claims the benefit of priority from Japanese Patent Application No. 2024-159989, filed on Sep. 17, 2024; the entire contents of which are incorporated herein by reference.

### FIELD

Embodiments described herein relate generally to a neural network device and a signal processing method.

### BACKGROUND

In recent years, with advances in computer hardware, typified by graphical processing units (GPU), artificial intelligence technology has been rapidly developing. For example, image recognition and classification techniques, typified by convolutional neural networks (CNN), have already been used in various scenes in the real world. Artificial intelligence technology that is widely used now is based on the mathematical model in which the behavior of a biological neural circuit network is simplified. Such artificial intelligence technology is therefore implemented using computers, such as GPUs.

However, the implementation of the artificial intelligence technology with GPUs requires a large amount of power. In particular, learning operation in which features are extracted from a large volume of data and stored comes with an enormous amount of computation. For this reason, such a learning operation requires a very large amount of power, and is considered to be difficult to execute in an edge device, for example.

On the other hand, although its energy consumption is as low as 20 W, the human brain constantly learns an enormous volume of data online. Therefore, a technique of performing information processing by relatively faithfully reproducing brain activity by electric circuits has been studied in various countries of the world.

In the brain's neural circuit network, information is transmitted from a neuron (nerve cell) to a neuron as a voltage spike. A coupler called a synapse couples a neuron to a neuron. A voltage spike generated by a certain neuron is input to a post-neuron as a subsequent stage via a synapse. At this time, the strength of the voltage spike input to the post-neuron is adjusted by a synaptic weight, which is the coupling strength of the synapse.

The synapse converts the voltage spike received from a pre-neuron at a preceding stage into a synaptic current corresponding to the synaptic weight and gives the synaptic current to the post-neuron. When the synaptic weight is large, the synapse gives a large synaptic current to the post-neuron; when the synaptic weight is small, the synapse gives a small synaptic current to the post-neuron.

Neurons hold inner potentials called membrane potentials. When having received a synaptic current from a synapse, the neuron increases the membrane potential in accordance with a magnitude of the received synaptic current. In addition, when no synaptic current is applied, the neuron reduces the membrane potential with the lapse of time. Accordingly, the neuron increases the membrane potential with continuous application of the synaptic current at short time intervals, and reduces the membrane potential with no application of the synaptic current for a long time. The neuron then generates a voltage spike when the membrane potential rises to reach a threshold potential being a firing threshold. The generation of a voltage spike by a neuron is called firing.

In addition, upon firing, a neuron returns its membrane potential to an initial potential. After returning the membrane potential to the initial potential, the neuron maintains the membrane potential at the initial potential for a given period of time called a refractory period of time. Thus, even when synaptic currents are applied during the refractory period of time, neurons do not increase the membrane potential. The neuron then changes the membrane potential after the end of the refractory period of time.

Such information processing mimicking the information transmission principle of the brain's neural circuit network is called spiking neural networks. The spiking neural network performs no numerical computation and performs information processing by increasing/reducing the membrane potential corresponding to the voltage spikes, generating the voltage spikes, and transmitting the voltage spikes by synapses. Conventional artificial intelligence requires an enormous amount of computation in learning operation. In contrast, the spiking neural network does not perform numerical computation, and thus is considered to efficiently perform data processing. For such reasons, in recent years, studies of implementing a spiking neural network on a semiconductor chip have been actively conducted.

When the spiking neural network is implemented on a semiconductor chip, the neuron is implemented by an analog circuit using members such as a resistor, a capacitor, and a comparator. This circuit accumulates charge corresponding to the received synaptic current in a capacitor, and uses a voltage generated by the charge accumulated in the capacitor as a membrane potential.

Meanwhile, in a case where an arithmetic operation neural network that performs arithmetic operations, represented by CNN and the like, is implemented by a conventional spiking neural network, there will be an output of a result different from a case where the arithmetic operation neural network is implemented by a digital operation circuit such as a Central Processing Unit (CPU).

### BRIEF DESCRIPTION OF THE DRAWINGS

FIG. 1 is a diagram illustrating an example of a configuration of a neural network device;

FIG. 2 is a diagram illustrating a connection relationship of peripheral circuits of a first neuron circuit;

FIG. 3 is a diagram illustrating a configuration of a first neuron circuit according to a first embodiment;

FIG. 4 is a diagram illustrating a configuration of a first synapse circuit according to a first example;

FIG. 5 is a diagram illustrating a configuration of a first synapse circuit according to a second example;

FIG. 6 is a diagram illustrating a configuration of a first synapse circuit according to a third example;

FIG. 7 is a diagram illustrating a configuration of a first synapse circuit according to a fourth example;

FIG. 8 is a diagram illustrating a configuration of a first synapse circuit according to a fifth example;

FIG. 9 is a timing chart illustrating an example of a waveform of a signal generated in the first neuron circuit; and

FIG. 10 is a diagram illustrating a configuration of a first neuron circuit according to a second embodiment.

### DETAILED DESCRIPTION

A neural network device according to an embodiment includes a plurality of synapse circuits and a plurality of neuron circuits. Each of the synapse circuits is assigned with a synaptic weight. Each of the neuron circuits is configured to output one or more spike signals. Each of the spike signals is a voltage pulse. Each of the synapse circuits is configured to acquire the one or more spike signals output from one of the neuron circuits, and, in response to acquiring one of the one or more spike signals, output a synaptic current with a current amount corresponding to the one or more spike signals and the synaptic weight assigned to a corresponding synapse circuit. A first neuron circuit out of the neuron circuits is configured to receive, via a first terminal of the first neuron circuit, a supply of the synaptic current from each of one or more first synapse circuits out of the synapse circuits, and output N spike signals (N is an integer of 2 or more) as the one or more spike signals. The first neuron circuit includes a charge accumulation circuit and a spike output circuit. The charge accumulation circuit is configured to accumulate charge corresponding to the synaptic current received via the first terminal and generate a membrane potential corresponding to the accumulated charge. The spike output circuit is configured to output at least an n-th spike signal out of the N spike signals when the membrane potential is higher than an n-th threshold potential (n is an integer of 1 or more and N or less) out of N threshold potentials different from each other.

Hereinafter, a neural network device 10 according to an embodiment will be described with reference to the drawings.

In a case where an arithmetic operation neural network that performs arithmetic operations, represented by CNN and the like, is implemented by a conventional spiking neural network, there will be an output of a result different from a case where the arithmetic operation neural network is implemented by a digital operation circuit such as a CPU. One of the causes of this is that, although the arithmetic operation neural network implemented by a digital operation circuit outputs numerical information with no upper limit from each neuron, the arithmetic operation neural network implemented by a conventional spiking neural network has information loss in neurons. More specifically, since the conventional spiking neural network returns the membrane potential to the initial potential after voltage spike firing in each neuron, information corresponding to a voltage component exceeding the firing threshold in the membrane potential is not transmitted to the subsequent neuron, leading to occurrence of loss in the transmitted information. Therefore, in a case where the arithmetic operation neural network is to be implemented by the spiking neural network with high accuracy, it is necessary to reduce such information loss. Hereinafter, embodiments for solving such problems will be described.

### First Embodiment

The neural network device 10 according to a first embodiment is a spike-type neural network configured by hardware components. For example, the neural network device 10 is mounted on a semiconductor device by a process such as a Complementary Metal Oxide Semiconductor (CMOS).

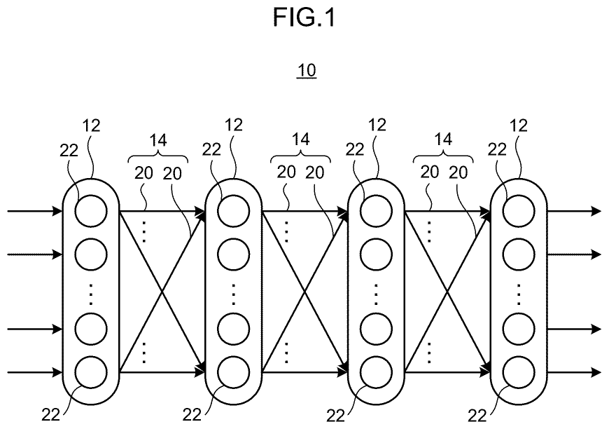

FIG. 1 is a diagram illustrating an example of a configuration of the neural network device 10. As an example, the neural network device 10 according to the first embodiment includes M (M is an integer of 2 or more) layers 12 and (M−1) synapse groups 14.

Each of the (M−1) synapse groups 14 includes a plurality of synapse circuits 20. A synaptic weight is assigned to each of the synapse circuits 20. The synaptic weights to be assigned to the synapse circuits 20 are set by learning processing. For example, the synaptic weights set for the synapse circuits 20 may be updated by a predetermined update rule such as Spike Timing Dependent Plasticity (STDP) or Spike Driven Synaptic Plasticity (SDSP).

Each of the M layers 12 includes a plurality of neuron circuits 22. The neuron circuits 22 each outputs one or more spike signals. Each of the one or more spike signals is a voltage pulse that changes from a first voltage to a second voltage, and returns to the first voltage after a lapse of a period of time from the change from the first voltage to the second voltage.

An m-th (m is an integer of 1 or more and (M−1) or less) synapse group 14 out of the (M−1) synapse groups 14 is disposed between an m-th layer 12 of the M layers 12 and an (m+1)-th layer 12 of the M layers 12.

Each of the synapse circuits 20 included in the m-th synapse group 14 acquires one or more spike signals output from any one neuron circuit 22 out of the neuron circuits 22 included in the m-th layer 12. When having acquired one or more spike signals, each of the synapse circuits 20 included in the m-th synapse group 14 outputs a synaptic current with a current amount corresponding to the synaptic weight that has been assigned and one or more spike signals that have been acquired. The synaptic weight may be represented by a binary value or may be represented by a multivalued discrete value of three or more values. Alternatively, the synaptic weight may be represented by an analog value, namely, by an amount of charge accumulated in a capacitor or the like or a resistance value of a variable resistor.

Each of the synapse circuits 20 included in the m-th synapse group 14 applies a synaptic current to one neuron circuit 22 out of the neuron circuits 22 included in the (m+1)-th layer 12.

Each of the neuron circuits 22 included in the (m+1)-th layer 12 out of the M layers 12 acquires a plurality of synaptic currents output from the m-th synapse group 14, and executes processing corresponding to a product-sum operation on the synaptic currents acquired. Note that the first layer 12 of the M layers 12 acquires a plurality of signals from an external device or an input layer. Subsequently, each of the neuron circuits 22 outputs one or more spike signal obtained by performing processing corresponding to an activation function on the signal representing the operation result.

In such a neural network device 10, the first layer 12 receives one or more signals from an external device or an input layer. Subsequently, the neural network device 10 outputs, from the m-th layer 12, one or more signals indicating a result of the operation executed by the neural network on the one or more signals received.

Such a neural network device 10 executes arithmetic neural network operation such as CNN. This makes it possible for the neural network device 10 to execute processing such as image recognition and classification processing with less energy consumption and a small-scale circuit without using a CPU or a GPU, for example.

The neural network device 10 is not limited to the structure in which signals are transferred only in the forward direction as illustrated in FIG. 1. For example, the neural network device 10 may include a configuration in which any of the neuron circuits 22 acquires a synaptic current from the synapse circuit 20 that has acquired one or more spike signals output by the neuron circuit 22 or from the synapse circuit 20 that has acquired one or more spike signals output by another neuron circuit 22 at a subsequent stage of the neuron circuit 22. Moreover, the neural network device 10 may be a recurrent neural network. For example, in a case where the neural network device 10 is a recurrent neural network, for example, the neural network device 10 is applicable to a reservoir computing apparatus 24.

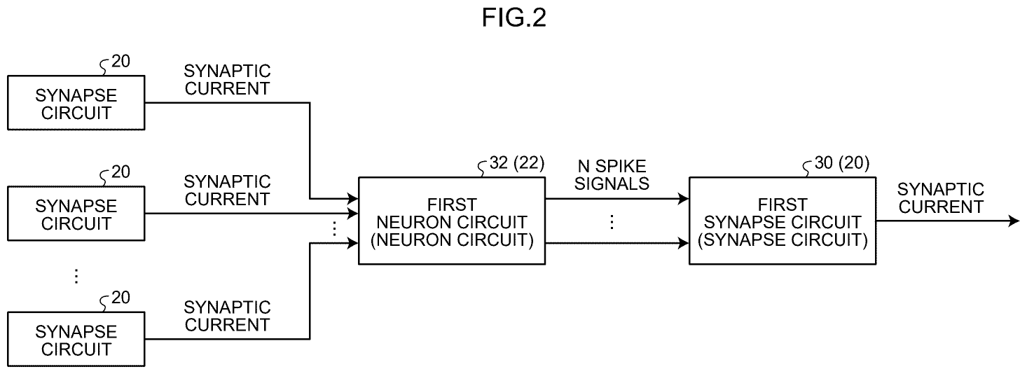

FIG. 2 is a diagram illustrating a connection relationship of peripheral circuits of a first neuron circuit 32.

Each of the neuron circuits 22 holds an inner potential called a membrane potential Vₘₑₘ. When having acquired a synaptic current from any of the synapse circuits 20 connected as a preceding stage, the neuron circuit 22 increases the membrane potential Vₘₑₘ in accordance with the magnitude of the synaptic current acquired. This makes it possible for each of the neuron circuits 22 to execute processing corresponding to the product-sum operation on the synaptic currents acquired.

When not having acquired the synaptic current, each of the neuron circuits 22 reduces the membrane potential Vₘₑₘ with the lapse of time. Therefore, each of the neuron circuits 22 increases the membrane potential Vₘₑₘ when having continuously acquired the synaptic current repeatedly at short time intervals, and reduces the membrane potential Vₘₑₘ when not having acquired the synaptic current for a long period of time. When the membrane potential Vₘₑₘ reaches a predetermined initial potential by reducing the membrane potential Vₘₑₘ with the lapse of time, each of the neuron circuits 22 stops reducing the membrane potential Vₘₑₘ.

Subsequently, when the membrane potential Vₘₑₘ has increased to a first threshold potential Vₜₕ₁ or more, each of the neuron circuits 22 fires and outputs at least one of the one or more spike signals to the synapse circuit 20 in the subsequent stage.

Here, at the time of firing, each of the neuron circuits 22 changes the number of spike signals to be simultaneously output out of one or more spike signals or the position of the spike signal to be output out of the one or more spike signals by the magnitude of the membrane potential Vₘₑₘ.

The first neuron circuit 32 of the neuron circuits 22 outputs N spike signals as the one or more spike signals. N is an integer of 2 or more. The N spike signals include a first spike signal, a second spike signal, . . . , up to an N-th spike signal.

The first neuron circuit 32 sets N different threshold potentials Vₜₕ. Each of the N threshold potentials Vₜₕ is predetermined. Specifically, the first neuron circuit 32 sets a first threshold potential Vₜₕ₁, a second threshold potential Vₜₕ₂, . . . , and an N-th threshold potential V_{thN}, which are each predetermined. The second threshold potential Vₜₕ₂ is higher than the first threshold potential Vₜₕ₁. The N-th threshold potential V_{thN} is higher than the (N−1)-th threshold potential V_{th(N-1)}. Thus, a p-th threshold potential Vₜₕₚ (p is an integer of 2 or more and N or less) out of N threshold potentials Vₜₕ is higher than a (p−1)-th threshold potential Vₜₕ₍ₚ₋₁₎ out of the N threshold potentials Vₜₕ.

When the membrane potential Vₘₑₘ is higher than the n-th threshold potential Vₜₕₙ out of the N threshold potentials Vₜₕ different from each other, the first neuron circuit 32 outputs at least the n-th spike signal out of the N spike signals. Note that n is an integer of 1 or more and N or less.

In the present embodiment, when the membrane potential Vₘₑₘ is higher than the first threshold potential Vₜₕ₁ and equal to or lower than the second threshold potential Vₜₕ₂, the first neuron circuit 32 outputs a first spike signal out of the N spike signals. When the membrane potential Vₘₑₘ is higher than the second threshold potential Vₜₕ₂ and equal to or lower than a third threshold potential Vₜₕ₃, the first neuron circuit 32 outputs the first spike signal and the second spike signal out of the N spike signals. Thus, when the membrane potential Vₘₑₘ is higher than the (p−1)-th threshold potential Vₜₕ₍ₚ₋₁₎ and equal to or lower than the p-th threshold potential Vₜₕₚ, the first neuron circuit 32 outputs (p−1) spike signals, namely, signals from the first spike signal to the p-th spike signal, out of the N spike signals. When the membrane potential Vₘₑₘ is higher than the N-th threshold potential V_{thN}, the first neuron circuit 32 outputs all the N spike signals.

The first neuron circuit 32 may be configured to output only the p-th spike signal when the membrane potential Vₘₑₘ is higher than the (p−1)-th threshold potential Vₜₕ₍ₚ₋₁₎ and equal to or lower than the p-th threshold potential Vₜₕₚ. The first neuron circuit 32 may be configured to output only the N-th spike signal when the membrane potential Vₘₑₘ is higher than the N-th threshold potential V_{thN}.

In addition, after having fired, each of the neuron circuits 22 returns the membrane potential Vₘₑₘ to the initial potential. For example, when the first spike signal out of the N spike signals has been output, the first neuron circuit 32 returns the membrane potential Vₘₑₘ to the initial potential.

In addition, during a refractory period of time being a predetermined time after firing, each of the neuron circuits 22 does not increase the membrane potential Vₘₑₘ and stops further firing even when a synaptic current is applied. After the end of the refractory period of time, each of the neuron circuits 22 starts accumulation of charges corresponding to the synaptic current. The initial potential is lower than the first threshold potential Vₜₕ₁.

Each of the synapse circuits 20 acquires one or more spike signal output from any one neuron circuit 22 of the neuron circuits 22.

Each of the synapse circuits 20 includes a current generation circuit. When having acquired one or more spike signals, each of the synapse circuits 20 uses the current generation circuit to output a synaptic current with a current amount corresponding to the synaptic weight that has been assigned and one or more spike signals that have been acquired, to the neuron circuit 22 in the subsequent stage.

For example, a first synapse circuit 30 of the synapse circuits 20 outputs a synaptic current with a current amount corresponding to a value obtained by multiplying a value corresponding to the number of spike signals simultaneously output out of the N spike signals output from the first neuron circuit 20-1 by a preset synaptic weight. Alternatively, the first synapse circuit 30 of the synapse circuits 20 may output, for example, a synaptic current with a current amount corresponding to a value obtained by multiplying a value corresponding to the position of spike signals output out of the N spike signals by a preset synaptic weight.

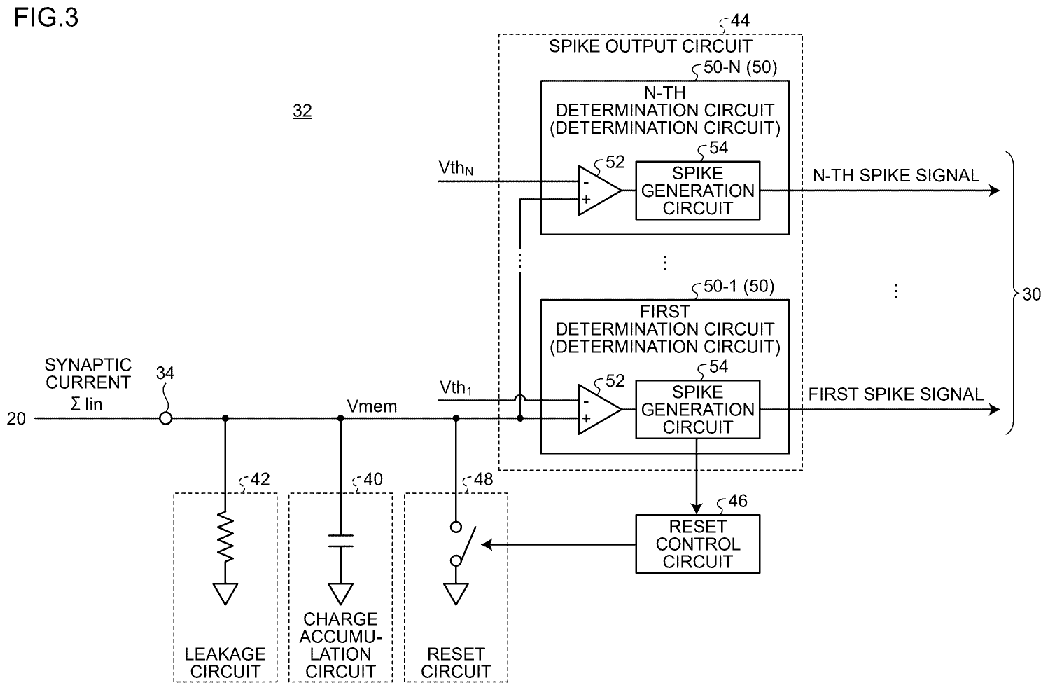

FIG. 3 is a diagram illustrating a configuration of the first neuron circuit 32 according to the first embodiment. In the neural network device 10, all of the neuron circuits 22 may have the same configuration as the first neuron circuit 32, or some of the neuron circuits 22 may have the same configuration as the first neuron circuit 32.

The first neuron circuit 32 is connected to one or more synapse circuits 20 out of the synapse circuits 20, as preceding stage circuits. The first neuron circuit 32 has a first terminal 34. In the first neuron circuit 32, a synaptic current is supplied to the first terminal 34 from each of one or more synapse circuits 20 connected, as a preceding stage, to the first neuron circuit 32.

The first neuron circuit 32 is connected to the first synapse circuit 30, as a subsequent stage. The first neuron circuit 32 outputs N spike signals to the first synapse circuit 30.

The first neuron circuit 32 includes a charge accumulation circuit 40, a leakage circuit 42, a spike output circuit 44, a reset control circuit 46, and a reset circuit 48.

The charge accumulation circuit 40 accumulates charge corresponding to the synaptic current supplied to the first terminal 34. The charge accumulation circuit 40 generates a membrane potential Vₘₑₘ corresponding to the accumulated charges, at the first terminal 34. Accordingly, the charge accumulation circuit 40 increases the membrane potential Vₘₑₘ generated at the first terminal 34 every time the synaptic current is supplied. For example, the charge accumulation circuit 40 is a capacitor connected between the first terminal 34 and the ground terminal.

The leakage circuit 42 reduces the charge accumulated in the charge accumulation circuit 40 with the lapse of time. The leakage circuit 42 is connected in parallel between two terminals of the charge accumulation circuit 40, and applies a leakage current from the first terminal 34 to the ground terminal to leak the charge accumulated in the charge accumulation circuit 40. Therefore, in a case where the synaptic current is not supplied, the charge accumulation circuit 40 reduces the membrane potential Vₘₑₘ generated at the first terminal 34, with the lapse of time.

An example of the leakage circuit 42 is a resistive element mounted on a semiconductor device. The resistive element is connected between the first terminal 34 and the ground terminal. The magnitude of the leakage current applied from the leakage circuit 42 is determined by the resistance value of the resistive element and the membrane potential Vₘₑₘ generated from the charge accumulation circuit 40. The resistive element has a relatively large resistance value of 100 MΩ or more, for example, and releases the charge accumulated in the charge accumulation circuit 40 over a sufficiently long time. Alternatively, the resistive element may be formed with a transistor. In this case, the leakage current value is determined by the gate voltage of the transistor.

The spike output circuit 44 sets N threshold potentials Vₜₕ. When the membrane potential Vₘₑₘ generated from the charge accumulation circuit 40 is higher than the n-th threshold potential Vₜₕₙ, the spike output circuit 44 outputs at least the n-th spike signal out of the N spike signals.

In the present embodiment, when the membrane potential Vₘₑₘ is higher than the (p−1)-th threshold potential Vₜₕ₍ₚ₋₁₎ and equal to or lower than the p-th threshold potential Vₜₕₚ, the spike output circuit 44 outputs (p−1) spike signals, namely, the first spike signal to the (p−1)-th spike signal out of the N spike signals. When the membrane potential Vₘₑₘ is higher than the N-th threshold potential V_{thN}, the spike output circuit 44 outputs all the N spike signals.

When the membrane potential Vₘₑₘ is higher than the (p−1)-th threshold potential Vₜₕ₍ₚ₋₁₎ and equal to or lower than the p-th threshold potential Vₜₕₚ, the spike output circuit 44 may output only the p-th signal such as the (p−1)-th spike signal. When the membrane potential Vₘₑₘ is higher than the N-th threshold potential V_{thN}, the spike output circuit 44 may output only the N-th spike signal.

In the present embodiment, the spike output circuit 44 includes N determination circuits 50.

The N determination circuits 50 exclusively correspond to any of the N threshold potentials Vₜₕ, and the corresponding threshold potential Vₜₕ is applied to the circuit. A first threshold potential Vₜₕ₁ is applied to a first determination circuit 50-1 out of the N determination circuits 50. An N-th threshold potential V_{thN} is applied to an N-th determination circuit 50-N out of the N determination circuits 50. An n-th threshold potential Vₜₕₙ is applied to an n-th determination circuit 50-n out of the N determination circuits 50.

The membrane potential Vₘₑₘ generated from the charge accumulation circuit 40 is applied to each of the N determination circuits 50.

Each of the N determination circuits 50 compares the membrane potential Vₘₑₘ with a corresponding threshold potential Vₜₕ out of the N threshold potentials Vₜₕ, and outputs a corresponding spike signal out of the N spike signals when the membrane potential Vₘₑₘ is higher than the corresponding threshold potential Vₜₕ. For example, the first determination circuit 50-1 compares the membrane potential Vₘₑₘ with the first threshold potential Vₜₕ₁, and outputs the first spike signal when the membrane potential Vₘₑₘ is higher than the first threshold potential Vₜₕ₁. The N-th determination circuit 50-N compares the membrane potential Vₘₑₘ with the N-th threshold potential V_{thN}, and outputs the N-th spike signal when the membrane potential Vₘₑₘ is higher than the N-th threshold potential V_{thN}. The n-th determination circuit 50-n compares the membrane potential Vₘₑₘ with the n-th threshold potential Vₜₕₙ, and outputs the n-th spike signal when the membrane potential Vₘₑₘ is higher than the n-th threshold potential Vₜₕₙ.

For example, the n-th determination circuit 50-n includes a comparator 52 and a spike generation circuit 54 mounted on a semiconductor device.

In the comparator 52, the n-th threshold potential Vₜₕₙ is applied to an inverting input terminal, while a non-inverting input terminal is connected to the first terminal 34. The comparator 52 outputs a determination signal representing whether the membrane potential Vₘₑₘ is higher than the n-th threshold potential Vₜₕₙ. For example, the comparator 52 outputs a determination signal representing a first value (for example, logical L) when having determined that the membrane potential Vₘₑₘ is not higher than the n-th threshold potential Vₜₕₙ, and indicating a second value (for example, logical H) when having determined that the membrane potential Vₘₑₘ is higher than the n-th threshold potential Vₜₕₙ.

The spike generation circuit 54 acquires the determination signal from the comparator 52. The spike generation circuit 54 outputs an n-th spike signal when the acquired determination signal changes from the first value indicating that the membrane potential Vₘₑₘ is not higher than the n-th threshold potential Vₜₕₙ to the second value indicating that the membrane potential Vₘₑₘ is higher than the n-th threshold potential Vₜₕₙ. More specifically, when the determination signal changes from the first value to the second value, the spike generation circuit 54 generates an n-th spike signal which is a voltage pulse that changes from the first voltage to the second voltage, and returns to the first voltage after a period of time has elapsed since the change from the first voltage to the second voltage. The spike generation circuit 54 gives the generated n-th spike signal to the first synapse circuit 30 connected at a subsequent stage of the first neuron circuit 32.

After any of the N spike signals has been output from the spike output circuit 44, the reset control circuit 46 controls to release the charge accumulated in the charge accumulation circuit 40. In the present embodiment, the reset control circuit 46 controls to release the charge accumulated in the charge accumulation circuit 40 in a predetermined period after the first spike signal is output from the first determination circuit 44-1 out of the N determination circuits 50.

For example, the reset control circuit 46 outputs the reset signal in the refractory period of time after the first spike signal is output from the first determination circuit 50-1 out of the N determination circuits 50. The refractory period of time is a predetermined time starting from the timing of the rear edge of the first spike signal being a voltage pulse. For example, the reset control circuit 46 outputs a reset signal representing logical H during the refractory period of time and indicating logical L during a period other than the refractory period of time.

After any of the N spike signals has been output from the spike output circuit 44, the reset circuit 48 controls to release the charge accumulated in the charge accumulation circuit 40 and connects the first terminal 34 to the ground terminal during the refractory period of time. In the present embodiment, when the first spike signal is generated, the reset circuit 48 releases the charge accumulated in the charge accumulation circuit 40 and connects the first terminal 34 to the ground terminal during the refractory period of time. For example, when the reset signal output from the reset control circuit 46 indicates logical L, the reset circuit 48 disconnects between the first terminal 34 and the ground terminal. When the reset signal output from the reset control circuit 46 indicates logical H, the reset circuit 48 short-circuits between the first terminal 34 and the ground terminal. The reset circuit 48 is implemented by a device such as a metal-oxide-semiconductor field-effect transistor (MOSFET), which turns on or off by a reset signal, for example.

Such a reset circuit 48 can release the charges accumulated in the charge accumulation circuit 40 to the ground terminal and return the membrane potential Vₘₑₘ generated from the charge accumulation circuit 40 to the initial potential. During the refractory period of time, the reset circuit 48 can control to direct a synaptic current supplied from the synapse circuit 20 in the preceding stage to the ground terminal so as to suppress accumulation of the charges in the charge accumulation circuit 40. During the refractory period of time, the reset circuit 48 can supply the potential of the ground terminal to each of the N determination circuits 50 instead of the membrane potential Vₘₑₘ generated from the charge accumulation circuit 40 so as to suppress generation of the spike signal. After the end of the refractory period of time, the reset circuit 48 can stop the charge release from the charge accumulation circuit 40 and can enable accumulation of the charge corresponding to the synaptic current supplied to the first terminal 34 in the charge accumulation circuit 40.

When the membrane potential Vₘₑₘ exceeds any of the N threshold potentials Vₜₕ at the time of firing, the first neuron circuit 32 having such a configuration can output the number of spike signals corresponding to the maximum threshold potential Vₜₕ equal to or lower than the membrane potential Vₘₑₘ out of the N threshold potentials Vₜₕ or output the spike signal at the position corresponding to the maximum threshold potential Vₜₕ equal to or lower than the membrane potential Vₘₑₘ out of the N threshold potentials Vₜₕ.

When, for example, the membrane potential Vₘₑₘ is higher than the (p−1)-th threshold potential Vₜₕ₍ₚ₋₁₎ and equal to or lower than the p-th threshold potential Vₜₕₚ, the first neuron circuit 32 can output (p−1) spike signals, namely, signals from the first spike signal to the (p−1)-th spike signal, out of the N spike signals. When the membrane potential Vₘₑₘ is higher than the N-th threshold potential V_{thN}, the first neuron circuit 32 can output all the N spike signals.

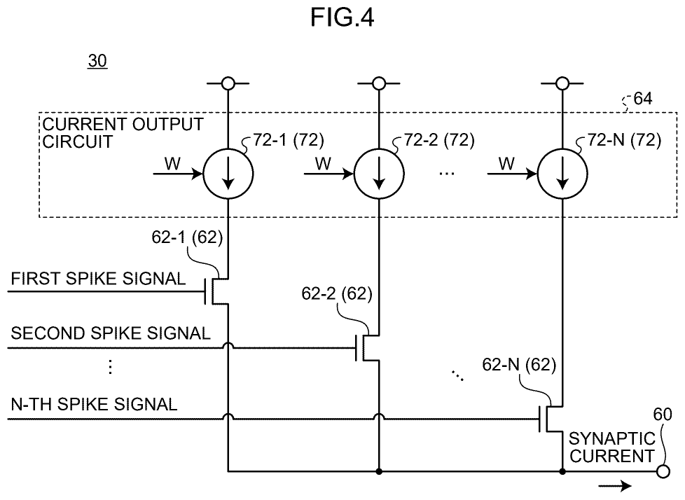

FIG. 4 is a diagram illustrating a configuration of the first synapse circuit 30 according to the first example.

The first synapse circuit 30 corresponding to the first example acquires N spike signals output from the first neuron circuit 32. Subsequently, the first synapse circuit 30 outputs, from an output terminal 60, a synaptic current with a current amount obtained by multiplying a value corresponding to the number of spike signals simultaneously indicating the second voltage out of the N spike signals by a preset synaptic weight.

The first synapse circuit 30 according to the first example includes N switch circuits 62 and a current output circuit 64.

The N switch circuits 62 correspond to the N spike signals output from the first neuron circuit 32 on a one-to-one basis. Each of the N switch circuits 62 turns off when the corresponding spike signal is the first voltage, and turns on when the corresponding spike signal is the second voltage.

For example, a first switch circuit 62-1 of the N switch circuits 62 corresponds to the first spike signal, and turns off when the first spike signal is the first voltage, and turns on when the first spike signal is the second voltage. An N-th switch circuit 62-N of the N switch circuits 62 corresponds to the N-th spike signal, and turns off when the N-th spike signal is the first voltage and turns on when the N-th spike signal is the second voltage. An n-th switch circuit 62-n of the N switch circuits 62 corresponds to the n-th spike signal, and turns off when the n-th spike signal is the first voltage and turns on when the n-th spike signal is the second voltage.

A synaptic weight (w) is assigned to the current output circuit 64. The current output circuit 64 outputs, from the output terminal 60, a synaptic current with a current amount corresponding to the synaptic weight that has been assigned and the number of switches that have turned on out of the N switch circuits 62.

In the present example, the current output circuit 64 includes N current sources 72. The N current sources 72 correspond to the N switch circuits 62 on a one-to-one basis. Each of the N current sources 72 is assigned with a synaptic weight, and applies a current corresponding to the synaptic weight that has been assigned.

A first current source 72-1 out of the N current sources 72 is connected in series with the first switch circuit 62-1 between the power supply terminal and the output terminal 60. The N-th current source 72-N out of the N current sources 72 and the N-th switch circuit 62-N are connected in series between the power supply terminal and the output terminal 60. The n-th current source 72-n out of the N current sources 72 and the n-th switch circuit 62-n are connected in series between the power supply terminal and the output terminal 60.

In the present example, each of the N switch circuits 62 is an N-type MOSFET. In this case, one terminal of each of the N current sources 72 is connected to the power supply terminal. Each of the N switch circuits 62 has a drain connected to a terminal on a side not connected to the power supply terminal of the corresponding current source 72, a gate provided with a corresponding spike signal, and a source connected to the output terminal 60.

In the first synapse circuit 30 corresponding to the first example of such a configuration, each of the N switch circuits 62 applies a current corresponding to the synaptic weight to the output terminal 60 when the corresponding spike signal reaches the second voltage. Accordingly, the first synapse circuit 30 of the first example can output, from the output terminal 60, a synaptic current with a current amount obtained by multiplying a value corresponding to the number of spike signals simultaneously indicating the second voltage out of the N spike signals by the synaptic weight.

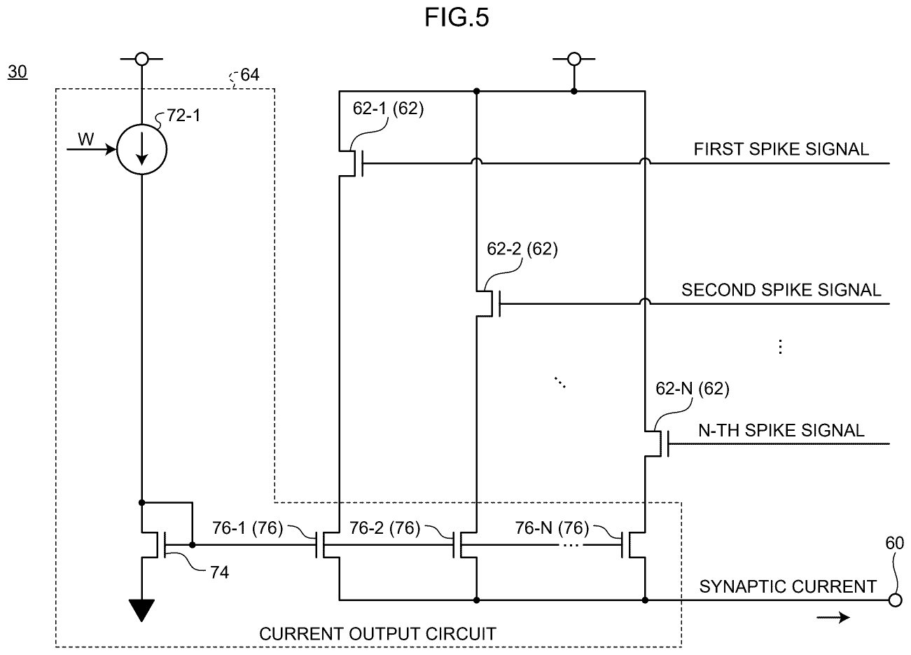

FIG. 5 is a diagram illustrating a configuration of a first synapse circuit 30 according to a second example. Since the first synapse circuit 30 according to the second example has substantially the same function as the first synapse circuit 30 according to the first example, components having substantially the same function and configuration are denoted by the same reference numerals, and a detailed description thereof will be omitted.

The current output circuit 64 according to the second example includes a first current source 72-1, a reference transistor 74, and N mirror transistors 76.

The first current source 72-1 is assigned with a synaptic weight and applies a current corresponding to the synaptic weight that has been assigned. One terminal of the first current source 72-1 is connected to a power supply terminal.

The reference transistor 74 is an N-type MOSFET, for example.

The drain of the reference transistor 74 is connected to a terminal of the first current source 72-1 on a side to which the power supply terminal of the first current source 72-1 is not connected. The source of the reference transistor 74 is connected to the ground terminal. The gate of the reference transistor 74 is connected to the drain. The reference transistor 74 like this can apply a current corresponding to the synaptic weight from the first current source 72-1 between the drain and the source.

Each of the N mirror transistors 76 is an N-type MOSFET, for example. Each of the N mirror transistors 76 has the same transistor characteristic.

Each gate of the N mirror transistors 76 is connected to the gate of the reference transistor 74. Each source of the N mirror transistors 76 is connected to the output terminal 60.

The N mirror transistors 76 correspond to the N switch circuits 62 on a one-to-one basis. Each of the N mirror transistors 76 is connected to a terminal on a side not connected to the power supply terminal, in the corresponding switch circuit 62 out of the N switch circuits 62.

The first mirror transistor 76-1 of the N mirror transistors 76 is connected to a terminal on a side not connected to the power supply terminal, in the first switch circuit 62-1. An N-th mirror transistor 76-N out of the N mirror transistors 76 is connected to a terminal on a side not connected to the power supply terminal, in the N-th switch circuit 62-N. The n-th mirror transistor 76-n out of the N mirror transistors 76 is connected to a terminal on a side not connected to the power supply terminal, in the n-th switch circuit 62-n.

In the present example, each of the N switch circuits 62 is an N-type MOSFET. In this case, each of the N switch circuits 62 has a drain connected to the power supply terminal, a source connected to the drain of the corresponding mirror transistor 76, and a gate provided with a corresponding spike signal.

In the first synapse circuit 30 according to the second example of such a configuration applies a current corresponding to the synaptic weight when each of the N mirror transistors 76 turns on the corresponding switch circuit 62, namely, when the corresponding spike signal indicates the second voltage. Accordingly, the first synapse circuit 30 of the second example can output, from the output terminal 60, a synaptic current with a current amount obtained by multiplying the number of spike signals indicating the second voltage out of the N spike signals by the synaptic weight.

In the first synapse circuit 30 according to the second example of such a configuration, each of the N switch circuits 62 applies a current corresponding to the synaptic weight to the output terminal 60 when the corresponding spike signal reaches the second voltage. Accordingly, the first synapse circuit 30 of the second example can output, from the output terminal 60, a synaptic current with a current amount obtained by multiplying a value corresponding to the number of spike signals simultaneously indicating the second voltage out of the N spike signals by the synaptic weight.

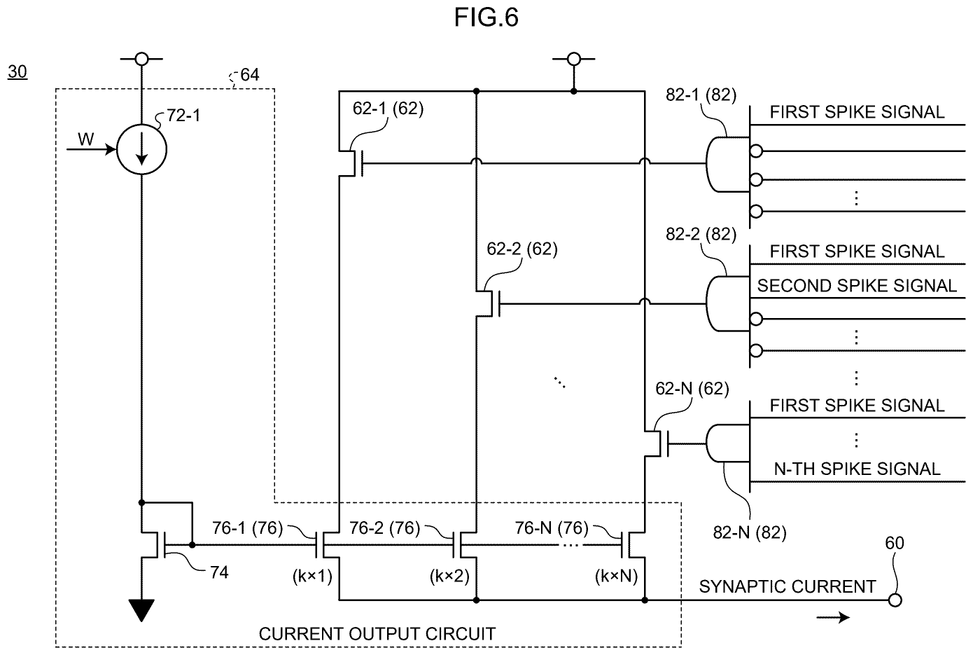

FIG. 6 is a diagram illustrating a configuration of the first synapse circuit 30 according to a third example. Since the first synapse circuit 30 according to the third example has substantially the same configuration as the first synapse circuit 30 according to the second example, components having substantially the same function and configuration are denoted by the same reference numerals, and a detailed description thereof will be omitted.

The first synapse circuit 30 according to the third example further includes N logical product circuits 82. For example, the N logical product circuits 82 included in the first synapse circuit 30 are a first logical product circuit 82-1, a second logical product circuit 82-2, . . . , and an N-th logical product circuit 82-N. Each of the N logical product circuits 82 performs a logical product operation with the first voltage as logical L and the second voltage as logical H.

The first logical product circuit 82-1 outputs a signal representing the logical product of the first spike signal and an inverted signal of each of the second to N-th spike signals. The second logical product circuit 82-2 outputs a signal representing the logical product of the first spike signal, the second spike signal, and an inverted signal of each of the third to N-th spike signals. The N-th logical product circuit 82-N outputs a signal representing the logical product obtained from the first spike signal to the N-th spike signal. Thus, the n-th logical product circuit 82-n outputs a signal representing the logical product of the first to n-th spike signals and individual inverted signals of the (n+1)-th to N-th spike signals.

The first switch circuit 62-1 turns on when the signal output from the first logical product circuit 82-1 indicates logical H, and turns off when the signal output from the first logical product circuit 82-1 indicates logical L. The second switch circuit 62-2 turns on when the signal output from the second logical product circuit 82-2 indicates logical H, and turns off when the signal output from the second logical product circuit 82-2 indicates logical L. The N-th switch circuit 62-N turns on when the signal output from the N-th logical product circuit 82-N indicates logical H, and turns off when the signal output from the N-th logical product circuit 82-N indicates logical L. Thus, the n-th switch circuit 62-n turns on when the signal output from the n-th logical product circuit 82-n indicates logical H, and turns off when the signal output from the n-th logical product circuit 82-n indicates logical L.

Each of the N mirror transistors 76 according to the third example has a different emitter area.

For example, the first mirror transistor 76-1 has an emitter area (k×1) times the emitter area of the reference transistor 74. k is a real number. Therefore, the first mirror transistor 76-1 can apply a current that is (k×1) times the current corresponding to the synaptic weight applied from the first current source 72-1. The N-th mirror transistor 76-N has an emitter area (k×N) times the emitter area of the reference transistor 74. Accordingly, the N-th mirror transistor 76-N can apply a current that is (k×N) times the current corresponding to the synaptic weight applied from the first current source 72-1. Thus, the n-th mirror transistor 76-n has an emitter area (k×n) times the emitter area of the reference transistor 74. Accordingly, the n-th mirror transistor 76-n can apply a current that is (k×n) times the current corresponding to the synaptic weight applied from the first current source 72-1.

In the first synapse circuit 30 according to the third example having such a configuration, when the first neuron circuit 32 has fired, any one of the N switch circuits 62 turns on and the others turn off. In the first synapse circuit 30 according to the third example applies a current when each of the N mirror transistors 76 turns on the corresponding switch circuit 62, namely, when the corresponding spike signal indicates the second voltage. Accordingly, in a case where the n-th spike signal out of the N spike signals indicates the second voltage, the first synapse circuit 30 according to the third example can apply a current (n×k) times the current corresponding to the synaptic weight to the output terminal 60. Accordingly, the first synapse circuit 30 of the third example can output, from the output terminal 60, a synaptic current with a current amount obtained by multiplying a value corresponding to the number of spike signals simultaneously indicating the second voltage out of the N spike signals by the synaptic weight.

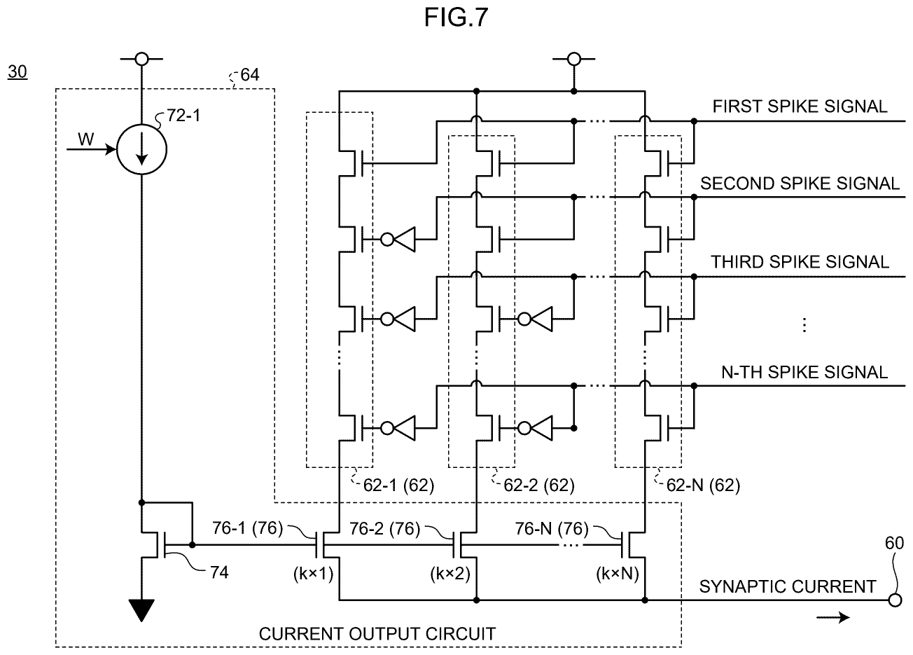

FIG. 7 is a diagram illustrating a configuration of the first synapse circuit 30 according to a fourth example. Since the first synapse circuit 30 according to the fourth example has substantially the same configuration as the first synapse circuit 30 according to the third example, components having substantially the same function and configuration are denoted by the same reference numerals, and a detailed description thereof will be omitted.

Each of the switch circuits 62 according to the fourth example includes an N-type MOSFET in which a drain and a source are connected in series. The N-type MOSFET having the drain and the source connected in series corresponds to the N spike signals on a one-to-one basis, and turns on or turns off in accordance with the corresponding spike signal or the inverted signal of the corresponding spike signal.

The first switch circuit 62-1 acquires the first spike signal and individual inverted signals of the second to N-th spike signals. The second switch circuit 62-2 acquires the first spike signal, the second spike signal, and individual inverted signals of the third to N-th spike signals. The N-th switch circuit 62-N acquires the N-th spike signal from the first spike signal. Thus, the n-th switch circuit 62-n acquires the first to n-th spike signals and individual inverted signals of the (n+1)-th to N-th spike signals.

In the first synapse circuit 30 having such a configuration according to the fourth example, similarly to the third example, when the first neuron circuit 32 has fired, any one of the N switch circuits 62 turns on and the others turn off. The first synapse circuit 30 according to the fourth example applies a current when each of the N mirror transistors 76 turns on the corresponding switch circuit 62, namely, when the corresponding spike signal indicates the second voltage. Accordingly, in a case where the n-th spike signal out of the N spike signals indicates the second voltage, the first synapse circuit 30 according to the fourth example can apply a current (n×k) times the current corresponding to the synaptic weight to the output terminal 60. Accordingly, the first synapse circuit 30 of the fourth example can output, from the output terminal 60, a synaptic current with a current amount obtained by multiplying a value corresponding to the number of spike signals simultaneously indicating the second voltage out of the N spike signals by the synaptic weight.

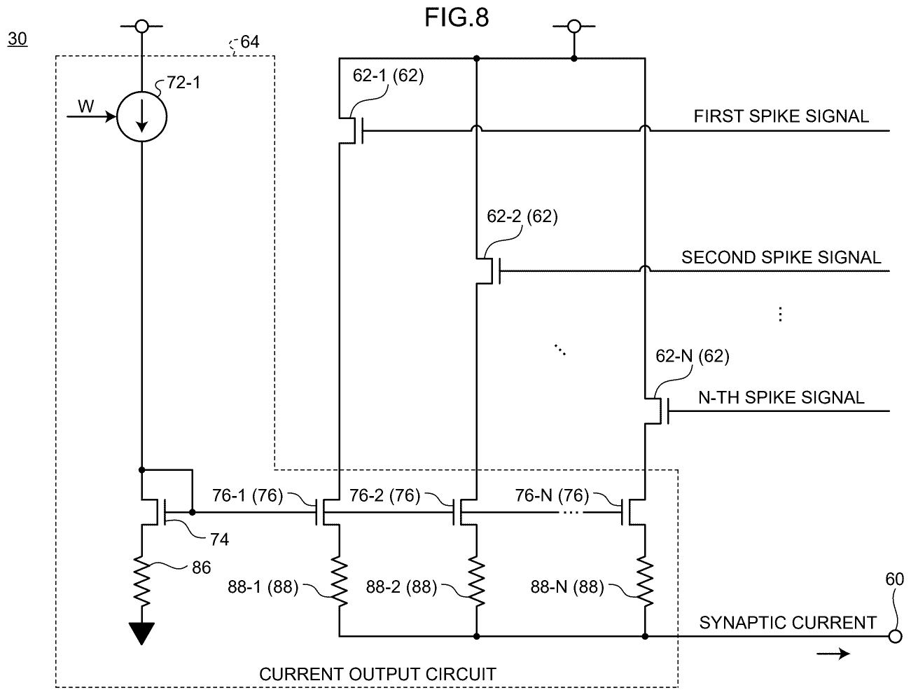

FIG. 8 is a diagram illustrating a configuration of the first synapse circuit 30 according to a fifth example. Since the first synapse circuit 30 according to the fifth example has substantially the same configuration as the first synapse circuit 30 according to the second example, components having substantially the same function and configuration are denoted by the same reference numerals, and a detailed description thereof will be omitted.

The current output circuit 64 according to the fifth example further includes a reference resistor 86 and N mirror resistors 88.

The reference resistor 86 is connected between the source of the reference transistor 74 and the ground terminal.

The N mirror resistors 88 correspond to the N mirror transistors 76 on a one-to-one basis. Each of the N mirror resistors 88 is connected between the source of the corresponding mirror resistor 88 out of the N mirror transistors 76 and the output terminal 60. For example, a first mirror resistor 88-1 of the N mirror resistors 88 is connected between the source of the first mirror transistor 76-1 and the output terminal 60. An N-th mirror resistor 88-N out of the N mirror resistors 88 is connected between the source of the N-th mirror transistor 76-N and the output terminal 60. An n-th mirror resistor 88-n out of the N mirror resistors 88 is connected between the source of the n-th mirror transistor 76-n and the output terminal 60.

Also in the first synapse circuit 30 according to the fifth example of such a configuration, each of the N switch circuits 62 applies a current corresponding to the synaptic weight to the output terminal 60 when the corresponding spike signal reaches the second voltage. Accordingly, the first synapse circuit 30 of the fifth example can output, from the output terminal 60, a synaptic current with a current amount obtained by multiplying a value corresponding to the number of spike signals simultaneously indicating the second voltage out of the N spike signals by the synaptic weight.

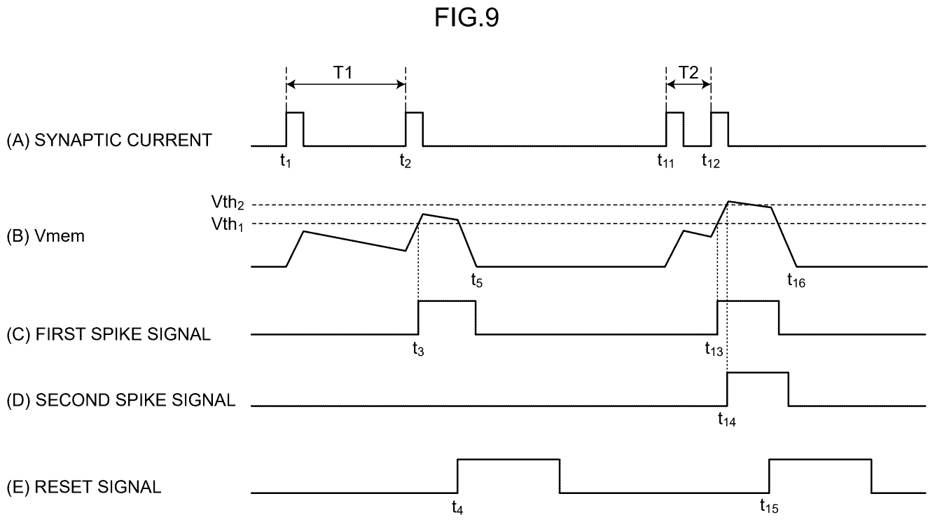

FIG. 9 is a timing chart illustrating an example of a waveform of a signal generated in the first neuron circuit 32. Note that (A) illustrates a waveform of a synaptic current received from the synapse circuit 20 in the preceding stage. (B) illustrates a waveform of the membrane potential Vₘₑₘ. (C) illustrates a waveform of the first spike signal. (D) illustrates a waveform of the second spike signal. (E) illustrates a waveform of the reset signal.

Immediately before time t1, the membrane potential Vₘₑₘ indicates an initial potential.

At time t1, the first neuron circuit 32 receives an input of the synaptic current with a first current amount from the synapse circuit 20 in the preceding stage. The input of the synaptic current with the first current amount from the synapse circuit 20 in the preceding stage at time t1 leads to an increase of the membrane potential Vₘₑₘ. However, in the example of FIG. 9, the membrane potential Vₘₑₘ is not to be higher than the first threshold potential Vₜₕ₁ just because of the input of the synaptic current with the first current amount from the synapse circuit 20 in the preceding stage at time t1. Therefore, the first neuron circuit 32 does not output any of the N spike signals just because of the input of the synaptic current with the first current amount from the synapse circuit 20 in the preceding stage at time t1.

During a period T1 from the input of the synaptic current at time t1 to the input of the next synaptic current, the first neuron circuit 32 reduces the membrane potential Vₘₑₘ with the lapse of time.

At time t2 subsequent to time t1, the first neuron circuit 32 receives an input of a next synaptic current with the first current amount from the synapse circuit 20 in the preceding stage. The input of the synaptic current with the first current amount at time t2 increases the membrane potential Vₘₑₘ. As a result, at time t3, the membrane potential Vₘₑₘ is to be higher than the first threshold potential Vₜₕ₁. Therefore, at time t3, the first neuron circuit 32 outputs the first spike signal out of the N spike signals. However, the membrane potential Vₘₑₘ is not to be higher than the second threshold potential Vₜₕ₂ just because of the input of the synaptic current with the first current amount at time t2. Therefore, at time t3, the first neuron circuit 32 does not output the second spike signal out of the N spike signals.

At time t4 after a lapse of a period of time from time t3, the first neuron circuit 32 sets the reset signal to logical H. With this setting, the membrane potential Vₘₑₘ reduces and indicates an initial potential at time t5 after the refractory period of time elapses from time t4.

Immediately before time t11, the membrane potential Vₘₑₘ indicates an initial potential.

At time t11, the first neuron circuit 32 receives an input of the synaptic current with a first current amount from the synapse circuit 20 in the preceding stage. The reception of the synaptic current with the first current amount from the synapse circuit 20 in the preceding stage at time t11 leads to an increase of the membrane potential Vₘₑₘ. However, in the example of FIG. 9, the membrane potential Vₘₑₘ is not to be higher than the first threshold potential Vₜₕ₁ just because of the input of the synaptic current with the first current amount at time t11. Accordingly, the first neuron circuit 32 does not output any of the N spike signals.

During a period T2 from the input of the synaptic current at time t11 to the input of the next synaptic current, the first neuron circuit 32 reduces the membrane potential Vₘₑₘ with the lapse of time.

At time t12 subsequent to time t11, the first neuron circuit 32 receives an input of a next synaptic current with the first current amount from the synapse circuit 20 in the preceding stage. At time t12, in the first neuron circuit 32, the input of the synaptic current with the first current amount from the synapse circuit 20 in the preceding stage leads to an increase of the membrane potential Vₘₑₘ. As a result, at time t13, the membrane potential Vₘₑₘ is to be higher than the first threshold potential Vₜₕ₁. Therefore, at time t13, the first neuron circuit 32 outputs the first spike signal.

Here, the period T2 from time t11 to time t12 is shorter than the period T1 from time t1 to time t2. Therefore, as a result of receiving the synaptic current with the first current amount from the synapse circuit 20 in the preceding stage at time t12, the membrane potential Vₘₑₘ becomes higher than the second threshold potential Vₜₕ₂ at time t14. Therefore, at time t14, the first neuron circuit 32 outputs the second spike signal out of the N spike signals.

At time t15 after a lapse of a period of time from time t13, the first neuron circuit 32 sets the reset signal to logical H. With this setting, the membrane potential Vₘₑₘ reduces and indicates an initial potential at time t16 after the refractory period of time elapses from time t15.

As described above, when the synaptic current is continuously input from the synapse circuit 20 in the preceding stage in a short time and the membrane potential Vₘₑₘ exceeds the second threshold potential Vₜₕ₂, the first neuron circuit 32 can output both the first spike signal and the second spike signal. Accordingly, the first neuron circuit 32 can transmit information corresponding to a voltage component exceeding the first threshold potential Vₜₕ₁ in the membrane potential Vₘₑₘ to the first synapse circuit 30 in the subsequent stage, as the second spike signal.

In this manner, the neural network device 10 according to the present embodiment can transmit the information corresponding to the voltage component exceeding the first threshold potential Vₜₕ₁ in the membrane potential Vₘₑₘ to the neuron circuit 22 in the subsequent stage with no information loss. With this configuration, corresponding to the neural network device 10 according to the present embodiment, it is possible to implement a spiking neural network with high accuracy with reduced loss of information to be transmitted.

### Second Embodiment

Hereinafter, a neural network device 10 according to a second embodiment will be described. Since the neural network device 10 according to the second embodiment has substantially the same function and configuration as the neural network device 10 of the first embodiment, components having substantially the same function and configuration as those of the first embodiment are denoted by the same reference numerals, and detailed description thereof is omitted except for their differences.

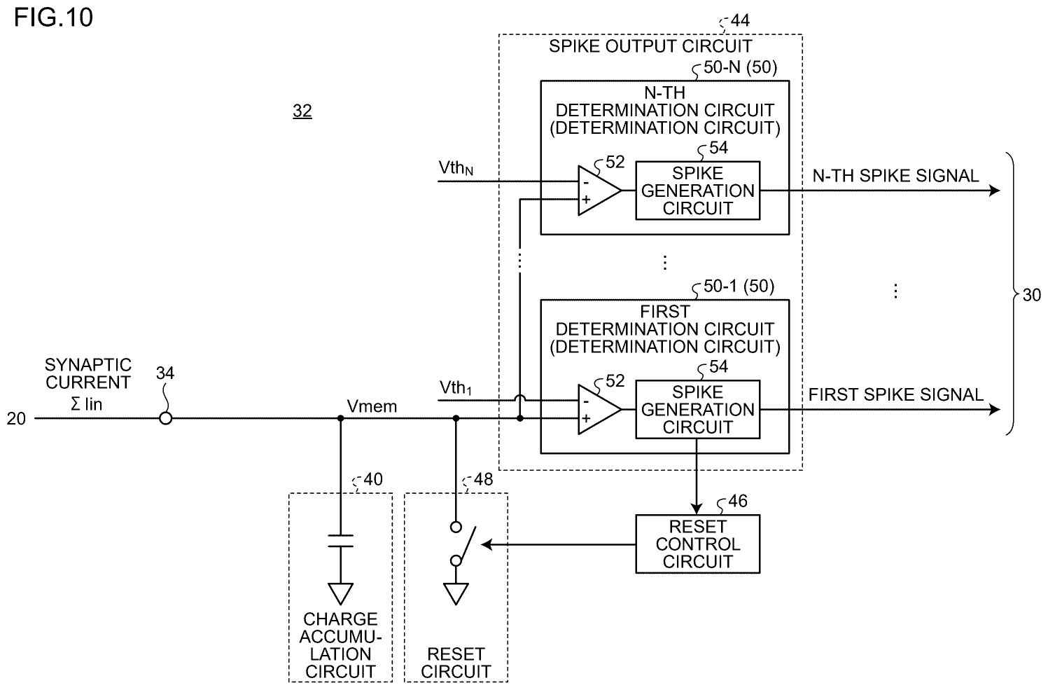

FIG. 10 is a diagram illustrating a configuration of a first neuron circuit 32 according to the second embodiment.

The first neuron circuit 32 according to the second embodiment includes a charge accumulation circuit 40, N determination circuits 50, a reset control circuit 46, and a reset circuit 48. Thus, the first neuron circuit 32 according to the second embodiment has no leakage circuit 42 as compared with the first embodiment.

The first neuron circuit 32 according to the second embodiment does not reduces the membrane potential Vₘₑₘ generated at the first terminal 34 with the lapse of time even when no synaptic current is supplied from the synapse circuit 20 in the preceding stage. Thus, the first neuron circuit 32 according to the second embodiment maintains the membrane potential Vₘₑₘ generated at the first terminal 34 during a period of time in which no synaptic current is supplied from the synapse circuit 20 in the preceding stage.

Similarly to the first embodiment, when the membrane potential Vₘₑₘ exceeds any of the N threshold potentials Vₜₕ, the first neuron circuit 32 according to the second embodiment having such a configuration can output the spike signals of the number corresponding to the maximum threshold potential Vₜₕ equal to or lower than the membrane potential Vₘₑₘ out of the N threshold potentials Vₜₕ. For example, when the membrane potential Vₘₑₘ is higher than the n-th threshold potential Vₜₕₙ and the membrane potential Vₘₑₘ is equal to or lower than the (n−1)-th threshold potential Vₜₕ₍ₙ₋₁₎ , the first neuron circuit 32 can output the first spike signal to the n-th spike signal.

Consequently, corresponding to the neural network device 10 according to the present embodiment, it is possible to implement a spiking neural network with high accuracy with reduced loss of information to be transmitted.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

### Supplementary Notes

The above embodiments can be summarized in the following technical schemes.

### Technical Scheme 1

A neural network device comprising:
a plurality of synapse circuits, each of the synapse circuits being assigned with a synaptic weight; and
a plurality of neuron circuits, each of the neuron circuits being configured to output one or more spike signals, each of the spike signals being a voltage pulse, wherein
each of the synapse circuits is configured to
   acquire the one or more spike signals output from one of the neuron circuits, and
   in response to acquiring one of the one or more spike signals, output a synaptic current with a current amount corresponding to the one or more spike signals and the synaptic weight assigned to a corresponding synapse circuit,
a first neuron circuit out of the neuron circuits is configured to
   receive, via a first terminal of the first neuron circuit, a supply of the synaptic current from each of one or more first synapse circuits out of the synapse circuits, and
   output N spike signals (N is an integer of 2 or more) as the one or more spike signals, and
the first neuron circuit includes
   a charge accumulation circuit configured to accumulate charge corresponding to the synaptic current received via the first terminal and generate a membrane potential corresponding to the accumulated charge, and
   a spike output circuit configured to output at least an n-th spike signal out of the N spike signals when the membrane potential is higher than an n-th threshold potential (n is an integer of 1 or more and N or less) out of N threshold potentials different from each other.

### Technical Scheme 2

The neural network device according to the technical scheme 1, wherein the first neuron circuit further includes a reset control circuit configured to release the charge accumulated in the charge accumulation circuit after one of the N spike signals is output.

### Technical Scheme 3

The neural network device according to the technical scheme 1, wherein
the spike output circuit includes N determination circuits, and
an n-th determination circuit out of the N determination circuits is configured to output the n-th spike signal when the membrane potential is higher than the n-th threshold potential.

### Technical Scheme 4

The neural network device according to the technical scheme 3, wherein
a p-th threshold potential (p is an integer of 2 or more and N or less) out of the N threshold potentials is higher than a (p−1)-th threshold potential out of the N threshold potentials, and
the first neuron circuit further includes a reset control circuit configured to release the charge accumulated in the charge accumulation circuit, the release of the charge being performed in a predetermined period of time after a first spike signal out of the N spike signals is output from a first determination circuit out of the N determination circuits.

### Technical Scheme 5

The neural network device according to the technical scheme 3 or 4, wherein the n-th determination circuit includes
a comparator configured to output a determination signal representing whether the membrane potential is higher than the n-th threshold potential, and
a spike generation circuit configured to output the n-th spike signal when the determination signal changes from a first value indicating that the membrane potential is not higher than the n-th threshold potential to a second value indicating that the membrane potential is higher than the n-th threshold potential.

### Technical Scheme 6

The neural network device according to any one of the technical schemes 1 to 5, wherein the charge accumulation circuit is a capacitor connected between the first terminal and a ground terminal.

### Technical Scheme 7

The neural network device according to any one of the technical schemes 1 to 6, wherein the first neuron circuit further includes a leakage circuit configured to reduce the charge accumulated in the charge accumulation circuit with a lapse of time.

### Technical Scheme 8

The neural network device according to the technical scheme 7, wherein the leakage circuit is a resistive element connected between the first terminal and a ground terminal.

### Technical Scheme 9

The neural network device according to any one of the technical schemes 1 to 8, wherein each of the one or more first synapse circuits is configured to output the synaptic current with a current amount, the current amount being obtained by multiplying
a value corresponding to the number of spike signals simultaneously output from the first neuron circuit out of the one or more spike signals or a value corresponding to a position of a spike signal having been output out of the one or more spike signals, and
the synaptic weight assigned to a corresponding first synapse circuit.

### Technical Scheme 10

The neural network device according to the technical scheme 9, wherein
the first synapse circuit includes N switch circuits and a current output circuit,
each of the N spike signals is a voltage pulse that changes from a first voltage to a second voltage and returns to the first voltage after a lapse of a given period of time after the change from the first voltage to the second voltage,
the N switch circuits correspond to the N spike signals on a one-to-one basis,
each of the N switch circuits turns off when a corresponding spike signal out of the N spike signals indicates the first voltage and turns on when the corresponding spike signal indicates the second voltage, and
the current output circuit outputs, from an output terminal, the synaptic current with a current amount corresponding to the assigned synaptic weigh and the number of switches turned on out of the N switch circuits.

### Technical Scheme 11

A signal processing method implemented by a neural network device including a plurality of synapse circuits and a plurality of neuron circuits, each of the synapse circuits being assigned with a synaptic weight, each of the neuron circuits being configured to output one or more spike signals, each of the spike signals being a voltage pulse, the signal processing method comprising:
by each of the synapse circuits,
   acquiring the one or more spike signals output from one of the neuron circuits, and
   in response to acquiring one of the one or more spike signals, outputting a synaptic current with a current amount corresponding to the one or more spike signals and the synaptic weight assigned to a corresponding synapse circuit;
by a first neuron circuit out of the neuron circuits,
   receiving, via a first terminal of the first neuron circuit, a supply of the synaptic current from each of one or more first synapse circuits out of the synapse circuits, and
   outputting N spike signals (N is an integer of 2 or more) as the one or more spike signals; and by the first neuron circuit,
   accumulating charge corresponding to the synaptic current received via the first terminal and generating a membrane potential corresponding to the accumulated charge, and
   outputting at least an n-th spike signal out of the N spike signals when the membrane potential is higher than an n-th threshold potential (n is an integer of 1 or more and N or less) out of N threshold potentials different from each other.

What is claimed is:

1. A neural network device comprising:
a plurality of synapse circuits, each of the synapse circuits being assigned with a synaptic weight; and
a plurality of neuron circuits, each of the neuron circuits being configured to output one or more spike signals, each of the spike signals being a voltage pulse, wherein
each of the synapse circuits is configured to
acquire the one or more spike signals output from one of the neuron circuits, and
in response to acquiring one of the one or more spike signals, output a synaptic current with a current amount corresponding to the one or more spike signals and the synaptic weight assigned to a corresponding synapse circuit,
a first neuron circuit out of the neuron circuits is configured to
receive, via a first terminal of the first neuron circuit, a supply of the synaptic current from each of one or more first synapse circuits out of the synapse circuits, and
output N spike signals (N is an integer of 2 or more) as the one or more spike signals, and
the first neuron circuit includes
a charge accumulation circuit configured to accumulate charge corresponding to the synaptic current received via the first terminal and generate a membrane potential corresponding to the accumulated charge, and
a spike output circuit configured to output at least an n-th spike signal out of the N spike signals when the membrane potential is higher than an n-th threshold potential (n is an integer of 1 or more and N or less) out of N threshold potentials different from each other.

2. The neural network device according to claim 1, wherein the first neuron circuit further includes a reset control circuit configured to release the charge accumulated in the charge accumulation circuit after one of the N spike signals is output.

3. The neural network device according to claim 1, wherein
the spike output circuit includes N determination circuits, and
an n-th determination circuit out of the N determination circuits is configured to output the n-th spike signal when the membrane potential is higher than the n-th threshold potential.

4. The neural network device according to claim 3, wherein
a p-th threshold potential (p is an integer of 2 or more and N or less) out of the N threshold potentials is higher than a (p−1)-th threshold potential out of the N threshold potentials, and
the first neuron circuit further includes a reset control circuit configured to release the charge accumulated in the charge accumulation circuit, the release of the charge being performed in a predetermined period of time after a first spike signal out of the N spike signals is output from a first determination circuit out of the N determination circuits.

5. The neural network device according to claim 3, wherein the n-th determination circuit includes
a comparator configured to output a determination signal representing whether the membrane potential is higher than the n-th threshold potential, and
a spike generation circuit configured to output the n-th spike signal when the determination signal changes from a first value indicating that the membrane potential is not higher than the n-th threshold potential to a second value indicating that the membrane potential is higher than the n-th threshold potential.

6. The neural network device according to claim 1, wherein the charge accumulation circuit is a capacitor connected between the first terminal and a ground terminal.

7. The neural network device according to claim 1, wherein the first neuron circuit further includes a leakage circuit configured to reduce the charge accumulated in the charge accumulation circuit with a lapse of time.

8. The neural network device according to claim 7, wherein the leakage circuit is a resistive element connected between the first terminal and a ground terminal.

9. The neural network device according to claim 1, wherein each of the one or more first synapse circuits is configured to output the synaptic current with a current amount, the current amount being obtained by multiplying
a value corresponding to the number of spike signals simultaneously output from the first neuron circuit out of the one or more spike signals or a value corresponding to a position of a spike signal having been output out of the one or more spike signals, and
the synaptic weight assigned to a corresponding first synapse circuit.

10. The neural network device according to claim 9, wherein
the first synapse circuit includes N switch circuits and a current output circuit,
each of the N spike signals is a voltage pulse that changes from a first voltage to a second voltage and returns to the first voltage after a lapse of a given period of time after the change from the first voltage to the second voltage,
the N switch circuits correspond to the N spike signals on a one-to-one basis,
each of the N switch circuits turns off when a corresponding spike signal out of the N spike signals indicates the first voltage and turns on when the corresponding spike signal indicates the second voltage, and
the current output circuit outputs, from an output terminal, the synaptic current with a current amount corresponding to the assigned synaptic weigh and the number of switches turned on out of the N switch circuits.

11. A signal processing method implemented by a neural network device including a plurality of synapse circuits and a plurality of neuron circuits, each of the synapse circuits being assigned with a synaptic weight, each of the neuron circuits being configured to output one or more spike signals, each of the spike signals being a voltage pulse, the signal processing method comprising:
by each of the synapse circuits,
acquiring the one or more spike signals output from one of the neuron circuits, and
in response to acquiring one of the one or more spike signals, outputting a synaptic current with a current amount corresponding to the one or more spike signals and the synaptic weight assigned to a corresponding synapse circuit;
by a first neuron circuit out of the neuron circuits,
receiving, via a first terminal of the first neuron circuit, a supply of the synaptic current from each of one or more first synapse circuits out of the synapse circuits, and
outputting N spike signals (N is an integer of 2 or more) as the one or more spike signals; and
by the first neuron circuit,
accumulating charge corresponding to the synaptic current received via the first terminal and generating a membrane potential corresponding to the accumulated charge, and
outputting at least an n-th spike signal out of the N spike signals when the membrane potential is higher than an n-th threshold potential (n is an integer of 1 or more and N or less) out of N threshold potentials different from each other.
